(19) United States
(12) Patent Application Publication
(10) Pub. No.: US 2014/0278738 A1
(43) Pub. Date: Sep. 18, 2014

(54) SYSTEMS AND METHODS FOR UNIFIED SCORING

(71) Applicants: Steven Feit, Dublin, OH (US); Katie Mowery, Dublin, OH (US); Monica Weller, Columbus, OH (US); Chris Rockwell, Sunbury, OH (US)

(72) Inventors: Steven Feit, Dublin, OH (US); Katie Mowery, Dublin, OH (US); Monica Weller, Columbus, OH (US); Chris Rockwell, Sunbury, OH (US)

(73) Assignee: Honda Motor Co., Ltd, Tokyo (JP)

(21) Appl. No.: 13/800,416

(22) Filed: Mar. 13, 2013

(51) Int. Cl. G06Q 30/02

(52) U.S. Cl. CPC G06Q 30/0201
USPC 705/7.29

(57) ABSTRACT

A scoring system and methodology thereof that is capable of combining quantitative and qualitative aspects to produce a composite score. A task can be performed and performance metrics can be recorded. The performance metrics can be scaled to facilitate their combination independent of units. Thereafter, an opinion evaluation can be provided to a user that performed the task. The user can provide feedback in subjective categories that is stored and/or converted to numerical values. The user can provide additional feedback relating to the relative importance of one or more of the subjective categories. The relative importance can be used to weight one or more subjective categories. Thereafter, the performance metrics and opinion evaluations can be combined to a unified composite score.

### TECHNICAL FIELD

This disclosure relates generally to scoring performance and satisfaction of a product, and, more particularly, generating a unified score that appropriately reflects both performance and satisfaction in one representative metric.

### BACKGROUND

Product manufacturers and evaluators wish to have a comprehensive picture of products in terms of the product's objective performance and subjective impressions among users and potential purchasers. Complete metrics, yielded from sources such as scientific product testing and elicited user feedback, facilitate beneficial research and development, continuous improvement, and ultimately success in the marketplace.

As suggested above, there are two general types of data that interest entities involved in evaluating products or features. The first type is performance. Data related to performance can provide an objective way to measure whether a product accomplishes its intended ends effectively for most users, and details regarding how those intended ends are accomplished. Performance can be measured in terms of time and space, accuracy and precision, costs or resources used, and/or other measurable information.

The second type of data can generally be referred to as “experience” and captures the subjective aspects of usage. There are many instances in market history where very well-designed products have failed, and poorly-designed products have achieved success. This is due to a variety of subjective factors perceived by consumers, whether or not such perceptions have any basis on the merits of the product related to performance. With globalism driving an increasingly competitive, accessible marketplace, interested parties must ensure user experience and satisfaction have a prominent role in their research, development and marketing.

However, it is in many instances challenging to view performance research and experience research simultaneously and as a whole. Rendering aspects of performance data unit-agnostic to accord with other performance data can be difficult. Determining appropriate weight or influence for experience data can be problematic inasmuch as it injects further subjectivity into already subjective information. Finally, there is no established, canonical means to convert and combine performance data and/or experience data to view the two in a single, integrated evaluation.

Accordingly, those with an interest in the outcome of products and features would stand to benefit if provided a flexible, robust mechanism for evaluating the products and features in terms of a single metric that considers both performance and experience data.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, can comprise one or more components that receive, analyze and utilize product performance data and scores, for example, data received via a measuring device or operator. Additional components can scale or adjust the performance data and scores to allow their use in a variety of applications.

In additional aspects, further components can receive and utilize experience data and scores. Additional components can weight or adjust the experience data and scores to allow their use in a variety of applications. Importance data can be received to assist with weighting or adjustment and improve the granularity of data collected.

In additional aspects of the innovation, components can utilize the performance data and experience data to generate composite scores based upon both. The data used in generating composite scores can include scaled and/or weighted quantities based on un-adjusted information, and/or the un-adjusted information itself. Performance data can be recorded, and at least a subset of the performance information can be scaled to accord with common indices.

In some method-based aspects of the innovation, performance data can be collected. At least a portion of the performance data can be scaled. After performance data is collected, experience information can be collected related at least in part to the performance. At least a subset of the experience information can be weighted. In some embodiments, weighting of the subset can occur based at least in part on the respective importance of a member of the subset.

Finally, some method-based aspects of the subject innovation can facilitate combination of performance data and experience data to produce a combined score.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a block diagram of an example embodiment of a system for producing an integrated score capturing quantitative and qualitative facets.

FIG. 2 illustrates a block diagram of an example system that generates a unified score in view of partial scores from disparate sources.

FIG. 3 illustrates a block diagram of an example system that manages testing that produces a score.

FIG. 4 illustrates a block diagram of an example methodology that generates a composite score.

FIG. 5 illustrates a block diagram of an example methodology that generates a composite score including both performance and subjective evaluation information.

FIG. 6 illustrates a sample scorecard for scoring performance data.

FIG. 7 illustrates a sample scorecard for scoring subjective data.

FIG. 8 illustrates a brief general description of a suitable computing environment wherein the various aspects of the subject innovation can be implemented.

FIG. 9 illustrates a schematic diagram of a client—server-computing environment wherein the various aspects of the subject innovation can be implemented.

### DETAILED DESCRIPTION

The innovation is now described, e.g., with reference to the drawings. In the following description, for purposes of explanation, numerous specific details are set forth in order to provide a thorough understanding of the subject innovation. It may be evident, however, that the innovation can be practiced without these specific details. In other instances, structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, a “product,” “product feature,” and similar terminology can be intended to relate to a good, service, or hybrid product, or any aspect or sub-aspect thereof, with which at least one performance standard can be associated. Products and/or features can be tested, benchmarked, prototyped, et cetera, in accordance with aspects herein. The description of products and/or features is intended to be non-limiting unless otherwise indicated.

As used herein, a “scale” can be a mapping between two or more lists or sets, and/or graduated series of points or ranges that associate a value on the scale with another. For example, scales can be used to convert values according to a defined function, formula, calculation or statistical analysis. In other examples, a scale can be wholly arbitrary, without a constant formula or curve connecting two or more associated quantities on the scale. “Scaling” can include the act of applying a scale to one or more sets of information to adjust and/or modify a value between one or more associated different values. A scale (or the act of scaling) can define an absolute value (e.g., ten seconds is a score of five) or a multiplier or equation used (e.g., time is converted to score by multiplying the number of seconds by two-divided-by-nine-seconds, yielding a unit-less score). Greater detail related to scales will be provided throughout this disclosure. While example scales are provided herein in tables, infra, such scales are provided to convey a general conceptual rubric for the use of scales with some aspects, and should not be viewed as limiting to the scope of the innovation.

In some embodiments, an “index” can be a list of information that associates otherwise disparate values. In one example, a sequential arrangement of material can permit a known index value to be located in the sequence, which directs an entity employing the index to another reference or unknown value based on the known index value.

As used herein, a “measuring device” can be most any device used to capture performance-related data. These can include common gauges such as speedometers and multimeters, force meters, motion sensors, et cetera. Measuring devices can also include various hardware, software, and combinations thereof designed specifically for assessing various aspects of task performance in relation to a product or feature. In some embodiments, a measuring device can be built into the product or feature being tested (or a prototype, simulator, or emulator representing the same). In other embodiments, a measuring device can be an external device capable of at least observing information resulting from action involving the product or feature.

As used herein, a “subject” can be (but is not necessarily limited to) one or more entities from a sample set engaged in testing a product or feature, where the test generates at least a portion of a score described herein.

Various “scores,” such as “performance score,” “quantitative score,” “satisfaction score,” “qualitative score,” “importance score,” and similar terms are used herein. Scores can be objective or subjective. Objective scores are generally objective measures recorded according to known, fixed units, or adjusted value scaled to convert the scores or make them unit-agnostic for use in other calculations. Subjective scores are generally quantified opinion (e.g., rated from one to ten, with ten being the best possible rating) or adjusted values weighted either to reflect the relative importance of a particular subjective score or to facilitate calculation with other scores tabulated differently. An importance score is a subjective score, and can be used in the calculation of weighting for other subjective scores.

Various qualitative, subjective categories are discussed with respect to inquiries and satisfaction herein. These can include categories like emotion, ease of use, aesthetics, capability, brand, and likeliness of recommending. Such categories can be rated by a subject according to a system that permits a numerical value to represent the subject's subjective opinion.

As used herein, “experience” can generally relate to such qualitative and subjective impressions a subject encounters or discerns during interaction with a product or feature being tested.

To provide additional context for the subjective evaluations, example definitions are provided. Such definitions are intended to capture the general spirit of subjective inquiry categories, rather than limit their scope. In one example, “emotion” can be evaluated such that a higher score relates to more positive emotions, and a lower score relates to more negative emotions. Emotions can include feelings evoked by the object of a test or the actions taken with it. Positive emotions can include excitement, enjoyment, appreciation, and others, and negative emotions can include frustration, displeasure, dissatisfaction, and others.

In another example, “ease of use” can indicate whether a user can readily understand how to use the product or feature, and whether that understanding is simple to convert to task accomplishment. Continuing with this example, a radio that is easy to use has intuitive controls that accord with a subject's expectations, and the controls are located in a place that is easy to reach and manipulate with minimal effort.

In another example, “aesthetics” can generally relate to appreciation for the form, either in relation to or distinct from, the function of a tested product or feature. The look, feel, “cool factor,” and others can influence a subject's impression of aesthetics.

In another example, “capability” can allow a subject to indicate whether a product or feature does what it is intended to do effectively. This can generally relate to the function, as opposed to the form, although individual subjects may allow interplay between these considerations.

In another example, “brand” can relate to a make, model, or other indication of a product or feature's origin. Many consumers prefer certain brands, and levels of commitment and pride can impact a subject's purchasing decisions. Here, a subject can indicate whether they approve of a product or feature's branding, whether the branding matches or mismatches the particular product or feature, and/or whether the brand otherwise positively or negatively influences their overall impression of the product or feature.

In another example, “likeliness of recommending” or similar phrases can indicate whether a subject would recommend that someone who trusts them use or purchase the tested product or feature.

“Importance scores” and the like can allow a subject to rate or rank categories according to what is most relevant. Invoking the examples above, a technical consumer can be most concerned with capability, and accordingly rate this much higher than aesthetics. A nontechnical consumer can alternatively rank ease of use and aesthetics highest, while placing capability lower in their hierarchy. Thus, persons reviewing study (testing) feedback from subjects can better understand subjects' overall appreciation for a product or feature, and individual inquiries can be weighted to allow the most important categories to exert a greater influence on composite scores than categories that disinterested one or more subjects.

As used herein, a “partial score” can indicate one or more scores that are used in calculating a composite score. For example, partial scores can be scores of similar unit or nature (e.g., quantitative, qualitative) prior to adjustment or combination yielding a final score that combines scores of dissimilar units or natures. In a more specific example, a partial score related to performance can combine task accomplishment, number of errors, and time of accomplishment, but not yet include additional task information or satisfaction inquiry responses.

The following includes example scenarios that illustrate the value of the innovation. These examples are intended to convey only limited embodiments, and are in no way intended to limit or constrain the scope of the subject innovation. Rather, the examples are intended to express some aspects of the spirit of the subject innovation. Those skilled in the art will appreciate additional breadth and applicability not expressly recited in these examples upon study of this disclosure.

Various attributes can be combined to generate a composite score capturing both operative and opinion aspects. Attributes can be collected in a “raw” form and stored as absolute values in “raw” units that are generally non-combinable without conversion. An example of attributes and their “raw scores” can be seen in Table 1 below.

TABLE 1
Example attributes and raw scores used
in calculation of composite score.

| Attribute | Raw Scale |
|---|---|
| Time on Task | Seconds |
| Errors | Total Number |
| | of Errors |
| Task Success | Yes/No |
| User Experience | 1 to 7 |

In order to generate a composite score that combines all attributes (e.g., in the example set forth in Table 1), raw attribute scores can be scaled, weighted, converted, and used in calculations to generate a combined final score.

The application is now described in relation to the figures.

Turning now to FIG. 1, illustrated is a block diagram of an example embodiment of a system 100 for producing an integrated score capturing quantitative and qualitative facets in accordance with some aspects herein. System 100 can include quantitative scoring component 110, qualitative scoring component 120, and composite calculation component 130.

Quantitative scoring component 110 can measure, record, and perform calculations related to quantitative feedback relating to human-machine interfaces and other aspects of function and design with which quantitative assessments can be associated.

Quantitative scoring component 110 can accept input from a variety of devices. Such devices can include (but are not limited to) clocks and/or watches, error monitors, simulators and/or emulators, and various other mechanical and/or electronic meters or monitors). Various biometric and/or physiological sensors can be employed to provide data from a test subject or other individual for use by quantitative scoring component 110 to improve the precision of quantitative information aggregated or generated by other devices (help determine or confirm, e.g., a time when an individual performed a motion, whether the motion was correct) or yield additional quantitative data related to the subject's body (e.g., eye focus, blood pressure, reaction time). In aspects, biometric or physiological information can be used to normalize data across a group of subjects having different abilities and/or characteristics.

In some embodiments, external measuring devices or data recorders can provide information to system 100. Various quantitative measurements can be recorded to a database or file which is concurrently or later accessed by quantitative scoring component 110. In such embodiments, the quantitative data can be formatted in advance for use by quantitative scoring component 110. Alternatively, quantitative scoring component 110 can include various recognition and/or conversion automation or tools to identify and utilize quantitative measurements in a database or stored file. In still other embodiments, various hybrid techniques will be appreciated by those skilled in the art.

For example, an experimental interface or control can be tested by a group of test subjects. The subjects can be evaluated for whether or not a task was completed, the number of errors identified, the time to completion, and others.

In embodiments, quantitative scoring component 110 can employ a plurality of numerically-unrelated values (different units or measurements, e.g., whether or not a task was completed, a time to completion, a number of errors) and scale values (and/or utilize a scale/mapping) to assess the numbers side-by-side or in sum.

For example, with regard to the examples set forth above, task completion can be measured as a binary (e.g., 1 or 0). The number of errors can be recorded as a total count, a modified count (e.g., particular errors worth more or less than others, subsequent errors worth more or less than initial errors), or a partial count (e.g., only count certain errors, only count up to a threshold number of errors, reduce number of errors based on other criteria). In some embodiments, the number of errors can include a threshold after which a separate metric (e.g., task not completed, adjust time to completion, and so forth). Time to completion can be measured in minutes, seconds, or other units.

TABLE 2
Success Multiplier

| | |
|---|---|
| Yes | 1 |
| No | 0 |

TABLE 3
Error Multiplier

| Number of | Multiplier |
|---|---|
| Errors | Applied |
| 0 | 1 |
| 1 | 0.857143 |
| 2 | 0.714286 |
| 3 | 0.571429 |
| 4 | 0.428571 |
| 5 | 0.285714 |
| 6 | 0.142857 |
| 7 or more | 0 |

TABLES 2 AND 3: Multipliers applied to scale raw quantitative scores.

Scaled, task completion can express its binary “1” or “0”, or be given (any) other alternative value for purposes of the test and/or an applied scale. In other embodiments, a scaled task completion score can be adjusted in view of other criteria (e.g., task completion reduced for hitting an error threshold or being over a specified time goal).

A scaled error number can include associating a particular number (or range) of errors with a desired value, or multiplying the number of errors by one or more scaling factors (e.g., arbitrary scaling constant, or different factors for different ranges of errors). Errors can be scaled according to means, medians, and percentages or fractions thereof. In some embodiments, standard deviations can be used to assign particular scaling factors or absolute values to particular numbers of errors. In some embodiments, standard deviations or other statistical analyses can be utilized with one or more datasets (as recorded by, for example, quantitative scoring component 110 or external measuring devices). In non-limiting examples, three standard deviations can be equal to a scaling factor of one-third, a value of four out of seven, or have its square root multiplied by two. Such numbers and/or calculations are purely arbitrary and intended for illustrative purposes only. It is to be understood by those skilled in the art that such examples are provided merely for purposes of illustration, and in no way intended to constrain alternative embodiments cognizable under the disclosures herein.

Similar to error numbers, time to completion can be scaled according to various values, ranges and statistical values. In an example, an average completion time can be 30 seconds. A time of 15 seconds or faster can be considered a “perfect” score and receive the maximum value, and a time of 45 seconds or slower can be considered a “failing” scores and receive the minimum value. In an alternative example, standard deviations can be employed to establish a plurality of scores used in time scaling.

TABLE 4
TABLE 4: Multiplier applied to scale raw quantitative time scores.

Time Multiplier

| | Time | Multiplier |
|---|---|---|
| | (Seconds) | Applied |
| | 0 | 1 |
| Minimum | 1 | 1 |
| | 2 | 0.95 |
| | 3 | 0.9 |
| | 4 | 0.85 |
| | 5 | 0.8 |
| | 6 | 0.75 |
| | 7 | 0.7 |
| | 8 | 0.65 |
| | 9 | 0.6 |
| | 10 | 0.55 |
| Average | 11 | 0.5 |
| | 12 | 0.45 |
| | 13 | 0.4 |
| | 14 | 0.35 |
| | 15 | 0.3 |
| | 16 | 0.25 |
| | 17 | 0.2 |
| | 18 | 0.15 |
| | 19 | 0.1 |
| | 20 | 0.05 |
| 1 Standard | 21 | 0 |
| Deviation | | |
| | 22 or more | 0 |

Various other quantities can be recorded and/or scaled using quantitative scoring component 110. For example, accuracy, precision, and various physical measurements (e.g., force, distance, speed) can be employed by quantitative scoring component 110 in the generation of various quantitative scores.

Scaling can be dynamic (or relative). For example, scaling numbers can be determined after a dataset is recorded but prior to scaled scoring. Scaling can be adjusted as the dataset changes or grows. In some embodiments, a plurality of scales can be employed, providing different scoring solutions for the same dataset through various iterations employing system 100.

Further, a plurality of measurements can be interdependent in the generation of scoring. For example, physical measurements (e.g., distance between an operator and a control) can be used to adjust scaling or scoring with regard to the same control. In a non-limiting example, a user's chair can be adjusted closer or farther with respect to the same control. The distance can be considered absolute or relative (e.g., total distance between chair and control, distance between chair and control as a proportion of a test subject's length of reach), and the different distances can be used to calculate adjustments to scoring or scaling of the same control in the same dataset.

Following quantitative scoring, (but not necessarily before or after any scaling or calculation employed in an embodiment) quantitative scoring component 110 can provide one or more scores to composite calculation component 130. In some embodiments, quantitative scoring component 110 can return (e.g., output, display, save) one or more quantitative scores prior to, or in lieu of, composite calculation component 130.

Qualitative scoring component 120 can process qualitative information gathered from test subjects, observers or researchers. In a non-limiting example, qualitative assessment can be accomplished by having a subject who completed a task (or another party) to rate or assign a value to a plurality of qualitative criteria. Such criteria can include, for example, emotion, ease of use, aesthetics, capability, brand, and likeliness to recommend. Various criteria can be broken into subsets for different treatment in later calculations.

Qualitative scoring component 120 can receive, record, analyze, and score such information in weighted and un-weighted subsets according to various analytical criteria. For example, one subset of qualitative information can be weighted, while another subset of qualitative information can be received, recorded, et cetera, in a usable form to which no weights are applied.

In an example, a first subset of information is received to be weighted. Weighting of qualitative factors can be accomplished according to methods similar to the scaling above (e.g., by ranges, standard deviation, et cetera). In alternative or complementary embodiments, weighting can be accomplished according to subjective factors, such as relative importance as viewed by test subjects, observers, or administrators (e.g., test designers, system designers, test managers).

In a non-limiting example, weighting can be accomplished by asking a test subject (or other party) to rank or assign a value in terms of importance to each qualitative criterion. In one embodiment, the first (weighted) subset of qualitative factors can include emotion, ease of use, aesthetics, capability and brand. A user can be asked to rank them from most to least important. Alternatively, a user can be asked to assign a non-exclusive value to each factor. In the alternative example, the user can assign a value between one and seven to each value, with seven indicating a most important factor, and permitting the same numerical importance value to be given to multiple factors. Thereafter, to facilitate appropriate weighting, the sum of all numerical importance values can be determined. Each relative weight can be divided by the sum to resolve a weighting factor. Finally, each qualitative score can be multiplied by its relative weighting factor determined by its importance.

A second (non-weighted) subset can be received or recorded in a value directly applicable to a partial score (e.g., portion of the qualitative score, score used in calculation of composite score(s) discussed infra). For the second subset, one or more qualitative inquiries can be scored (continuing with the earlier example, from one to seven), and no subsequent calculation occurs—the score is recorded and/or utilized “as-is.” In one non-limiting example, a user can respond regarding whether they are likely to recommend the tested feature. The user can rate the feature between one and seven, with seven being most likely to recommend, and the score can be provided un-weighted.

Following completion of qualitative scoring, including any weighting or calculation in embodiments employing such, one or more qualitative scores can be provided by qualitative scoring component 120 to composite calculation component 130. In some embodiments, qualitative scores can be returned (e.g., saved, displayed, output) prior to, or in lieu of, composite calculation component 130.

Composite calculation component 130 can receive scores (e.g., scaled or unscaled, weighted or unweighted, and combinations thereof) to produce a composite score that provides the ability to view quantitative and qualitative factors in a single unified score. In some embodiments, composite calculation component 130 can perform scaling, weighting, and various statistical calculations to relate the scores. In other embodiments, composite calculation component 130 receives scores from quantitative scoring component 110 and qualitative scoring component 120 processed in advance such that the scores can be summed, averaged or otherwise combined to determine a final composite score. For example, in a non-limiting embodiment involving a final composite score resulting from summing, a score of three to twenty-one can account for quantitative points, using three quantitative scores scaled to values between one and seven. In the same example, a score of two to fourteen can account for qualitative points. The fourteen points can include two scores between one and seven. One of metrics can account for a subset of weighted qualitative scores, which are weighted and summed to be placed on the appropriate seven point index. The other can be an un-weighted score, which is a single score that was originally recorded on the appropriate seven point index, or is adjusted to place it on the appropriate index while retaining its same relative value without further calculation. Thus, a thirty-five point total can be yielded in this non-limiting example. A more detailed example will provide further detail below.

An example functioning of system 100 can be as follows. A new feature is tested by a group of test subjects. A task is completed relating to the new feature, and quantitative scoring component 110 evaluates whether each user completes the task, and if so, the time to completion and number of errors (if any) encountered attempting the task. These scores can be scaled to one a one-to-seven point score. If the task is completed, a given user can receive all seven points; if it is not, the user can be given one or zero points. The time to completion, or time of attempt, can likewise be scaled to a one-to-seven point score. For example, an average time to completion can be 90 seconds. Three standard deviations slower than the average can be a score of one, two standard deviations slower can be a score of two, and one standard deviation slower can be a score of three. A time of 30 seconds can be a score of four. One, two and three standard deviations faster can represent scores of five, six and seven. Finally, the number of errors can correspond to scoring. Standard deviations, particular numbers, or ranges of errors can correspond to specific values from one to seven as well. The three scaled scores—success of completion, time to completion, and number of errors, can be summed to determine a quantitative partial score from three to twenty-one.

After the task, the test user can respond to a series of qualitative questions. Rating each on a scale of one to seven, the user can rate emotion, ease of use, aesthetics, capability, and brand from one to seven, with seven exhibiting a strong preference in favor for the feature, and with one exhibiting a dislike of the feature. An additional question regarding whether the user is likely to recommend the feature to others can be presented, which is also provided between one and seven.

Continuing with the non-limiting example, the user can be asked about the relative importance of the first five factors (emotion, ease of use, aesthetics, capability, and brand) one a scale of one to seven. The user can assign a score of seven to each score they consider most important. In embodiments, such scores can be exclusive (e.g., must use each number between one and seven only once) or non-exclusive (e.g., can mark all or none as one, can mark all or none as seven, and so forth). For purposes of this example, the scores are non-exclusive, and the user assigns scores according to their own preferences, rating the first three factors five, and the latter two factors three. The sum of their importance scores—twenty-one—is now used to determine a weighting for each factor. The three factors assigned a score of five have their qualitative score multiplied by an importance fraction of five twenty-firsts, and the two factors assigned a score of three have their score multiplied by an importance fraction of three twenty-firsts.

After weighting the qualitative score of each, a partial qualitative score is determined by summing the weighted qualitative scores with the non-weighted qualitative score (likelihood of recommending). In the example set forth above, the qualitative partial score would thus be between two and fourteen.

Continuing with the example, the partial quantitative score and partial qualitative score can be summed. This will provide an integrated composite score—in this case, out of thirty-five, with twenty-one points calculated from quantitative data and fourteen points calculated from qualitative data—that easily relates a plurality of otherwise numerically-unrelated data points.

It is to be appreciated that unlimited combinations or scoring graduations can be employed in the same fashion as the example above. For example, the total number of points can be adjusted to fit a total of one hundred points, or various partial scores can have higher relative values (e.g., qualitative worth two-thirds of a composite score and quantitative only adjusted to be worth one-third, scoring out of a fifty point composite score, scoring as a percentage). Further, composite calculation component 130 can make a determination based on absolute or relative criteria (e.g., score above seventy-five percent of possible points, score higher than previous alternatives, score below predetermined or statistically calculated threshold) to resolve whether the tested feature should be pursued, retested, or abandoned.

Turning now to FIG. 2, illustrated is a block diagram of an example system 200 that generates a unified score in view of partial scores from disparate sources in accordance with some aspects herein. System 200 can include (but is not limited to, and in some embodiments need not include all of) task management component 210, inquiry handling component 220, performance scoring component 230, satisfaction rating component 240, performance scaling component 250, satisfaction weighting component 260, and composite scoring component 270.

Task management component 210 can facilitate performance of at least one task by a subject. The subject can, for example, attempt to perform a task related to a tested feature and/or control in a product. For example, a tested feature and/or control in a product can be a new means for the feature and/or control. In a particular example, tested automobile designs can include a variety of tested means for controlling the motion of the automobile (e.g., steering wheels, shifters, pedals) or various systems therein (e.g., radio, climate control, navigation, communication equipment), and a subject can perform driving and control tasks in environments including the tested means. In this way, early production, prototypes or simulations can be evaluated to determine whether users can perform the tasks intended by the tested means, and how well the tasks are performed.

In some embodiments, task management component 210 is built into or connected directly to a product and/or feature, and/or prototypes or simulations thereof. In other embodiments, task component is a separate device or component that prompts a user to proceed in at least a portion of a task.

In still other embodiments, task management component 210 can be a device or component with no physical connection to one or more products and/or features being tested that receives information relating to earlier-performed tasks. In a non-limiting example, the information can include data related to whether the task was performed, the time of performance, and any errors encountered during performance. This data can include results from one or more subjects, and in some embodiments, one or more tasks (or one or more performances/attempts for the same task) by the same subject.

Upon performance of one or more tasks, task management component 210 can interact with inquiry handling component 220, discussed infra, to initiate one or more subjective inquiries at least related to a test.

After a task is performed, task management component 210 can provide details about the task and its performance (e.g., time to completion, number of errors) to performance scoring component 230. Performance scoring component 230 can score one or more facets of information about the task and its performance. Scoring or other activity executed by performance scoring component 230 can include aggregating, combining, averaging, summing, organizing, plotting, and performing various other administrative and/or calculative actions with regard to performance data. In an embodiment, performance scoring component 230 can sort datasets (e.g., as spreadsheets, in various markup languages, as tables), calculate means and medians, determine variance and/or standard (or other) deviation(s), identify and perform actions with regard to outliers, and/or complete other organization or analyses on information from task management component 210.

In some embodiments, task management component 210 and performance scoring component 230 can be a single component, or series of related sub-components. Various embodiments of system 200 can permit information regarding tasks to flow through or directly to components in orders not depicted in FIG. 2. For example, a task can be performed, and at least one metric related to the task can proceed, in its original form and/or units, to performance scaling component 250 without interaction with or manipulation by task management component 210 and/or performance scoring component 230. Various embodiments will be appreciated by those skilled in the art in which these and other components described with respect to system 200 or other aspects herein are combined, eliminated, or expressed alternatively, with respect to all information related to a task or specific subsets thereof (e.g., some data “passes through” but not all).

Performance scoring component 230 can return task-related data (modified or as-received from task management component 210) to performance scaling component 250. Performance scaling component 250 can produce a partial score based on performance information by scaling information related to the task to accord with a common scoring convention. In some embodiments, performance scaling component 250 can apply absolute scales (e.g., arbitrary values), provided in advance or based on previous information. In other embodiments, performance scaling component 250 can generate scales by calculating statistical values related to information received from performance scoring component 230 and/or other components in or in communication with system 200. Various hybrid techniques (e.g., calculate new scales with regard to some aspects and not others) will be appreciated by those skilled in the art upon review of the disclosures herein.

Performance scaling component 250 can provide a partial score to composite scoring component 270, including scaled (and, in some embodiments, un-scaled) data relating to task performance. Composite scoring component 270 can use the partial score from performance scaling component 250 to calculate a final score, which also includes information routed or modified by inquiry handling component 220, satisfaction rating component 240, and/or satisfaction weighting component 260, as described infra.

After at least one task is attempted, task management component 210 can trigger inquiry handling component 220. In alternative embodiments, inquiry handling component 220 can act independent of task management component 210. Inquiry handling component 220 can initiate at least one subjective inquiry related to an attempted task. In some embodiments, inquiry handling component 220 can include means for presenting one or more subjective inquiries at least in part by an electronic device that accepts a subject's feedback and returns the feedback to inquiry handling component 220 or other components.

Subjective inquiries presented by inquiry handling component 220 can include inquiries relating to the subject's experience with the feature(s) and/or product(s) associated with the task. For example, inquiry handling component 220 can query a subject (or trigger such a query by another component) to rate aspects such as emotion, ease of use, aesthetics, capability, and brand with respect to the task and associated features and/or products. In some embodiments, inquiry handling component 220 can query a user to rate their likeliness to recommend the features and/or products to another person.

In addition to causing presentation of inquiries relating to subjective feedback with respect to a performance test, inquiry handling component 220 can cause presentation (as well as response and handling of response information) of one or more importance inquiries related to the subjective feedback. In a non-limiting example, a subject can be asked to rate the categories in which they provided subjective feedback in terms of their importance. For example, after a subjective inquiry, a subject can be solicited to rate, on a scale of one to seven, a particular category's importance in relation to other categories. In this example, the importance inquiry can be constructed rigidly or flexibly. A rigid inquiry can require a least to most important ranking of all categories with no ties. A flexible inquiry can permit non-exclusive ratings and allows a user to equally rank categories with regard to importance.

Inquiry handling component 220 can pass inquiry results to satisfaction rating component 240. Satisfaction rating component 240 can aggregate, combine, average, sum, organize, plot, and/or perform various other administrative and calculative actions with regard to data received from inquiry handling component 220. In various embodiments, it is understood that inquiry handling component 220 and satisfaction rating component 240 can be combined into a single component or expressed alternatively in various combinations.

Satisfaction rating component 240 provides data related to subjective inquiries to satisfaction weighting component 260. In some embodiments, satisfaction rating component 240 can prepare data received via inquiry handling component 220 for use by satisfaction weighting component 260.

At least one of satisfaction weighting component 260 and satisfaction rating component 240 can calculate one or more weighting factors. Weighting factors can be based at least in part on a plurality of supplemental information received from inquiry handling component 220. In some embodiments, a weighting factor can be calculated by first summing supplemental ratings associated with categories. In embodiments, a supplemental rating can relate to importance. For example, if one category receives an importance rating of five, and a second category receives a rating of four, and there are only two categories, their sum is nine. After computing the sum, each category can have its weighting factor computed by dividing its importance rating by the sum of ratings. Thus, in the earlier example, the first category's weighting factor would be five-ninths, and the second category's weighting factor would be four-ninths

Satisfaction weighting component 260 can utilize weighting factors for at least a subset of information gathered by at least inquiry handling component 220 and/or satisfaction rating component 240. In some embodiments, after weighting factors are determined for at least a subset of inquiry responses, these weighting factors can be applied to one or more. In embodiments where a weighting factor can be produced for all subsets of inquiry responses, factors that are regarded as “non-weighted” (or, to be given full value in a composite score) can be treated as having a weighting factor of one.

Satisfaction weighting component 260 can produce a partial score based on the subjective inquiry responses. The partial score can include a subset of weighted scores. A numerical value associated with a response to a subjective inquiry response can be multiplied by its individual importance value based weighting factor or another weighting factor (e.g., arbitrary weighting factor for category, arbitrary weighting factor for subset of categories). In some embodiments, some categories can have no weight applied. Satisfaction weighting component 260 can sum all categories and/or inquiry responses received from inquiry handling component 220 (and/or satisfaction rating component 240). In embodiments, the sum of all categories and/or inquiry responses is summed by subsets, where one or more subsets have weights applied to values prior to summing. The sum total of all inquiry responses can produce a partial score based on subjective inquiry responses and/or categories rated subsequent to completing one or more tasks with evaluated performance.

As indicated by dotted lines spanning task management component 210 and inquiry handling component 220, performance scoring component 230 and satisfaction component 230, and performance scaling component 250 and satisfaction weighting component 260, system 200 can optionally facilitate communication between various components that, in the embodiment described above, are largely confined to “silos” that can generally be deemed to treat performance and satisfaction separately. In some embodiments, however, categories of performance and categories of satisfaction can be cross-referenced and/or dependent upon one another to effect alternative calculative techniques and/or better represent a dataset for purposes of analysis. In alternative or complementary embodiments, correlation and/or comparison can occur between performance and satisfaction using partial scores or individual category assessments (e.g., task performance or subjective inquiry rating categories).

Various aspects herein can be practiced on mobile devices. In an embodiment, at least one component from system 200 is embodied on a mobile device such as a cellular telephone, personal digital assistant, notebook computer, tablet, smart device, and/or others. In some embodiments, a mobile device can prompt or record data related to task performance (e.g., task management component 210, performance scoring component 230). Complementary or alternative embodiments can allow a task to be performed on a mobile device, such as where the mobile device is the product or feature, or can simulate or emulate use of the product or feature (e.g., task management component 210, performance scoring component 230). In complementary or alternative embodiments, a mobile device can facilitate a subjects' submission of satisfaction information (e.g., inquiry handling component 220, satisfaction rating component 240). In still another embodiment, a mobile device can perform calculations using performance and/or satisfaction data to generate scores and enable output of partial or composite scores (e.g., performance scaling component 250, satisfaction weighting component 260, composite scoring component 270).

Similarly, various distributed computing techniques can be employed without deviating from embodiments represented by FIG. 2 or other aspects herein. For example, subjects can perform tasks at a variety of locations, or perform tasks in multiple locations. In another example, performance and satisfaction evaluation can occur in different locations. A plurality of entities can utilize data from one or more subsets in a plurality of locations. Various wired and wireless networks, and/or data storage means can be employed to facilitate embodiments of system 200 and other systems and methods herein in distributed environments. Despite this, the foregoing is in no way intended to limit the practice of multiple or all aspects in one location.

Turning now to FIG. 3, illustrated is a block diagram of an example system 300 for managing testing that produces a score in accordance with some aspects herein. System 300 can include protocol component 310, score card component 320, and factor adjustment component 330. System 300 can be used to design, administer, and score tests related to products and/or features related to which a performance-measurable task can be completed.

Protocol component 310 can determine testing protocols to accomplish desired testing goals. Testing protocols can include determining appropriate demographics and sample group size to determine how many subjects possessing particular traits can be involved. For example, the proportions or numbers of demographics such as age, gender, education, income level, and others can be determined by protocol component 310 to ensure the testing group can meet the testing's sought ends.

Protocol component 310 can further set forth the testing procedures for one or more persons of a sample group of subjects. For example, one or more tasks, and associated performance and inquiry evaluations, can be standardized. The standardized tasks and evaluations can be randomized in order of execution, and evaluations can be modified (e.g., “flip” positives to negatives, counter-balancing) between subjects to avoid skewing results across all tasks and questions.

In some embodiments, protocol component 310 can integrate pre-determined tasks and evaluations (objective and subjective) to a testing procedure.

Score card component 320 provides an organized way to receive and render testing results (objective and subjective) upon completing testing such as that defined by protocol component 310. Score card component 320 can receive testing results (or have testing results manually provided and/or input) for tabulation, storage, and calculation. The score cards can then be “scored,” alone or in combination with factor adjustment component 330, to facilitate integrated composite scores capturing both objective performance and subjective satisfaction aspects.

Factor adjustment component 330 can calculate or be provided with scales and/or weighting factors. In some embodiments, factor adjustment component 330 uses at least one portion of information from score card component 320 to generate a relative scale or weighting factor in view of one or more performance and/or satisfaction results. In alternative embodiments, factor adjustment component 330 does not calculate scales and/or weighting factors, but is provided in advance for one or more categories. In some embodiments, different adjustments can be made to different categories and/or scores.

After scoring all subsets, including application of adjustment factors via factor adjustment component 330, at least one of factor adjustment component 330 and score card component 320 can sum two or more scores (including, but not limited to, partial scores related to performance and/or satisfaction) to generate a final composite score. In some embodiments, this score can be returned in its final form. In alternative or complementary embodiments, various other scores used to calculate the final form (e.g., raw scores, adjustment factors such as scaling and/or weighting, scaled and/or weighted scores, partial scores) can be displayed to demonstrate aspects of the composite score or its calculation.

Turning now to FIG. 4, illustrated is a block diagram of an example methodology 400 that generates a composite score in accordance with aspects herein.

At 400, methodology 400 can begin and proceed to 402 where tasks are performed. While tasks are performed at 402, performance data can be recorded. Performance data can include, but is not limited to, whether the task is completed, the time taken to complete the task, and a number of errors that occur during the task attempt.

At 404, inquiries can be performed related to the task. The inquiries at 404 can include questions about satisfaction regarding the task and/or products and features related to the task. Inquiries at 404 can also include importance rankings related to descriptions or sentiments in conjunction with the task and/or products and features. In some embodiments, importance rankings can tie directly to the satisfaction inquiries. For example, satisfaction inquiries can set forth a series of categories in which the task and/or associated products and features are rated according to particular descriptors, sentiments, or conclusions. Thereafter, a subject who has completed the task can ask which descriptors, sentiments, or conclusions are most important.

The inquiries at 404 can be performed immediately following one task, after completion of all tasks, or at another time. In some embodiments, inquiries at 404 can be repeated after a task is re-attempted again. In other embodiments, inquiries at 404 can be provided in accordance of attempting a task, based on non-experiential opinions, to facilitate tracking of changes in opinion after performing the task personally. Such arrangements are presented for illustrative purposes only, and other arrangements for surveying task subjects before, during and after testing will be appreciated by those skilled in the art upon review of the disclosures herein.

At 406, data related to performing tasks at 402 and responses from inquiries at 404 can be scaled and/or weighted. In some embodiments, scales and/or weights can be calculated at 406, in addition to applying them to task- and inquiry-related data. After scaling task-related data (if relevant) and weighting inquiry-related data (if relevant), partial scores can be generated pertinent to performance-related data and subjective inquiry-related data.

At 408, the partial scores and/or other scaled and/or weighted scores calculated at 406 can be combined to generate a final score. The final score generated at 408 can be calculated by summing partial scores in some embodiments. In alternative embodiments, various calculations can be performed to discover sums, differences, multiples and factors. Various statistical analyses can be performed. In some embodiments, various graphical outputs (e.g., curves, plots, charts) can be provided with or to express the final score at 408. After calculating the final score at 408, methodology 400 ends. In some embodiments, methodology 400 can repeat, or occur in multiple simultaneous iterations, to permit calculation using multiple sample sets, recalculation with updated sample sets, or repeated calculation on the same sample set using different constraints and/or properties (e.g., different outlier cutoff values, scales, weighting equations).

Turning now to FIG. 5, illustrated is a block diagram of an example methodology 500 that generates a composite score including both performance and subjective evaluation information. At 502, methodology 500 begins and proceeds to identify a sample group at 502. In some embodiments, identification of a sample group can suggest a sample group size and specific demographic break-outs to ensure a sufficiently representative set prior to initiating testing. In aspects, a sufficiently representative set can include consideration of minimum and optimal group sizes to ensure statistical significance from a group being identified (alone or in combination with one or more other groups). In some embodiments, databases of potential subjects can be maintained, and identification of the sample group at 502 can include recommending specific subjects to be contacted to satisfy the requirements of a particular sample group. In such an embodiment, an additional function at 502 can include contacting all persons selected for inclusion in the set. In some embodiments, additional persons can be automatically contacted at 502 until the sample group is full, as indicated by acceptance from a contacted subject.

After identifying a sample group of subjects at 502, a scorecard can be generated at 504. The scorecard can be standardized to facilitate common understanding and statistically appropriate representations. Further, standardization can facilitate common scoring for disparate units and/or enable numerical representation of non-numerical data as described throughout the disclosures herein.

After a standard scorecard is generated at 504, at least a portion of the scorecard can optionally be randomized at 506. Different randomizations can be utilized to one or more subjects to ensure the integrity of the inquiry process and sound responsive data across all aspects.

Once the sample group is identified at 502 and scorecard(s) prepared at 504 and 506, a task can be prompted at 508. One or more subjects from the sample group can attempt the task at 508, with data about the task being recorded. In some aspects, data such as whether the task as completed, one or more errors encountered during the task, and a time of completion can be recorded. At 510, the task can be scored. Scoring can include at least recording one or more raw data points related to task performance. In some embodiments, other calculations can occur related to the tasks. In still other alternative or complementary embodiments, raw or partially processed data that can be used to generate a partial score based on task performance can be returned or displayed at 510.

At 512, a determination is made as to whether more tasks are required for the testing at hand. If more tasks are required, methodology 500 returns to 508, where the next task is prompted. Thereafter, the subsequent task is scored at 510, and the inquiry regarding additional tasks at 512 is repeated. In some embodiments, 510 and 512 can be swapped, allowing for completion of all tasks before any scoring occurs.

If no additional tasks are required at 512, methodology 500 proceeds to 514, where the sample group engages in a subjective evaluation of the task and related product features. This evaluation is generally two-part. First, an evaluation related to qualities or impressions of the task and related product features occurs. If more than one evaluation occurs, a second part can include ranking the different evaluated qualities or impressions according to their individual significance or importance to the rating subject.

At 516, a determination is made regarding whether additional subjective evaluations are to be performed. If additional attributes or categories can be evaluated by a subject, methodology 500 returns to 514, where evaluations can be completed. If no additional evaluations remain to be completed, methodology 500 can proceed to 516. It is to be appreciated that subjective evaluation can occur earlier or elsewhere within methodology 500.

After performance data is collected during scoring at 510 and subjective evaluations receive responses at 514, the data required to calculate weights and/or adjust scales is available. At 518, weights can be calculated (and/or scales can be calculated or modified) to facilitate the appropriate weighting and/or scaling of evaluation and/or task data for use in partial scores.

After weighting factors (and/or scales) are calculated at 518, methodology 500 proceeds to scale task-related performance data and weight subjective evaluation data at 520. Once each set of data has been modified, respectively, partial scores are complete. These partial scores are utilized at 522 to calculate a final composite score including both objective performance and subjective evaluation data. The final score can be returned at 522, and the methodology can end thereafter at 524.

Turning now to FIG. 6, illustrated is a sample scorecard 600 for scoring performance data. As shown, raw performance data (e.g., time, number of errors, whether completed) can be recorded. A scale can be applied permitting adjusted scores to be generated based at least in part on the raw scores. Thereafter, a partial score for performance can be generated by summing the scaled scores. Such a performance score can be utilized in composite scores as described herein.

In some embodiments, a scorecard such as that described in FIG. 6 can be displayed to a subject, administrator, or other entity. In some embodiments, aspects of FIG. 6 are representative of variables in various systems or methods that are not presented to the user but employed in calculations that result in later-returned outputs. Various embodiments permit items described as single variables or pieces of information to be effected in plurality. Likewise, various embodiments permit items shown as multiple variables or pieces of information to be combined into a single aspect.

While FIG. 6 illustrates one example of a performance scorecard, it is appreciated that this drawing may be presented in a simplified fashion, and is only intended to capture some descriptive aspects suggesting the spirit of some aspects of the innovation. FIG. 6 should not be interpreted to be limiting in any functional or aesthetic capacity.

Turning now to FIG. 7, illustrated is a sample scorecard 700 for scoring subjective data. As shown, raw scores associated with various subjective categories (e.g., emotion, capability, aesthetics, brand, ease of use) can be recorded. An importance score can be provided and stored for each subjective category. The importance scores can be summed to a total used to facilitate calculation of a weighting factor associated with each subjective category. Thereafter, weighted category scores can be generated based at least in part on the raw scores.

A partial score for subjective evaluations can be generated by summing the scores. Scores are added to the summation including (or after application of) weighting. In some embodiments, an additional non-weighted score (e.g., likeliness to recommend) can be included, whereby the raw score is summed without adjustment to be included in a partial subjective evaluation score.

Such a subjective evaluation score can be utilized in composite scores as described herein. The sum of weighted and non-weighted scores can provide a user experience partial score. The user experience partial score can be combined with a performance score (e.g., as shown in FIG. 6) to obtain a composite score integrating disparate performance and evaluation data as a single metric.

In some embodiments, a scorecard such as that described in FIG. 7 can be displayed to a subject, administrator, or other entity. In some embodiments, aspects of FIG. 7 are representative of variables in various systems or methods that are not presented to the user but employed in calculations that result in later-displayed outputs. Various embodiments permit items described as single variables or pieces of information to be effected in plurality. Likewise, various embodiments permit items shown as multiple variables or pieces of information to be combined into a single aspect.

While FIG. 7 illustrates one example of a satisfaction scorecard, it is appreciated that this drawing may be presented in a simplified fashion, and is only intended to capture some descriptive aspects suggesting the spirit of some aspects of the innovation. FIG. 7 should not be interpreted to be limiting in any functional or aesthetic capacity.

FIG. 8 illustrates a brief general description of a suitable computing environment wherein the various aspects of the subject innovation can be implemented, and FIG. 9 illustrates a schematic diagram of a client—server-computing environment wherein the various aspects of the subject innovation can be implemented.

With reference to FIG. 8, the exemplary environment 800 for implementing various aspects of the innovation includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA). Alternatively or in addition, an external hard disk drive 815 may also be configured for external use in a suitable chassis (not shown), a magnetic disk drive, depicted as a floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drives 814, 815 magnetic disk drive 816 and optical disk drive 820 can be connected to the system bus 808 by a hard disk drive interface 824, a magnetic disk drive interface 826 and an optical drive interface 828, respectively. The interface 824 for external drive implementations can include Universal Serial Bus (USB), IEEE 1394 interface technologies, and/or other external drive connection technologies.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and system memory 806, including an operating system 830, one or more application programs 832, other program modules 834 and program data 836. All or portions of the operating system, applications, modules, and/or data can also be cached in the RAM 812. It is appreciated that the innovation can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, et cetera

A monitor 844 or other type of display device is also connected to the system bus 808 via an interface, such as a video adapter 846. In addition to the monitor 844, a computer typically includes other peripheral output devices (not shown), such as speakers, printers, et cetera

The computer 802 may operate in a networked environment using logical connections via wired and/or wireless communications to one or more remote computers, depicted as remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842 as depicted. It should be appreciated that the modem 858 can be connected via a USB connection, a PCMCIA connection, or another connection protocol. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, et cetera) to provide secure, reliable, fast wireless connectivity. A Wi-Fi network can be used to connect computers to each other, to the Internet, and to wired networks (which use IEEE 802.3 or Ethernet).

FIG. 9 is a schematic block diagram of a sample-computing environment 900 that can be employed for practicing aspects of the aforementioned methodology. The system 900 includes one or more client(s) 902. The client(s) 902 can be hardware and/or software (e.g., threads, processes, computing devices). The system 900 also includes one or more server(s) 904. The server(s) 904 can also be hardware and/or software (e.g., threads, processes, computing devices). The servers 904 can house threads to perform transformations by employing the components described herein, for example. One possible communication between a client 902 and a server 904 may be in the form of a data packet adapted to be transmitted between two or more computer processes. The system 900 includes a communication framework 906 that can be employed to facilitate communications between the client(s) 902 and the server(s) 904. The client(s) 902 are operatively connected to one or more client data store(s) 908 that can be employed to store information local to the client(s) 902. Similarly, the server(s) 904 are operatively connected to one or more server data store(s) 910 that can be employed to store information local to the servers 904.

What has been described above includes examples of the various versions and/or aspects. It is, of course, not possible to describe every conceivable combination of components or methodologies for purposes of describing the various versions and/or aspects, but one of ordinary skill in the art may recognize that many further combinations and permutations are possible. Accordingly, the subject specification intended to embrace all such alterations, modifications, and variations that fall within the spirit and scope of the appended claims.

It is appreciated that, while aspects of the subject innovation described herein focus in wholly-automated systems, this should not be read to exclude partially-automated or manual aspects from the scope of the subject innovation. Practicing portions or all of some embodiments manually does not violate the spirit of the subject innovation.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers, and so forth). Such components, inter alia, can automate certain mechanisms or processes performed thereby to make portions of the systems and methods more adaptive as well as efficient and intelligent. By way of example and not limitation, the aggregation of password rules can infer or predict support or the degree of parallelism provided by a machine based on previous interactions with the same or like machines under similar conditions. As another example, touch scoring can adapt to hacker patterns to adjust scoring to thwart successful approaches.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A scoring system, comprising:
a quantitative component that receives a plurality of quantitative scores relating to a product;
a scaling component that scales the plurality of quantitative scores to produce a plurality of scaled scores;
a qualitative component that receives a plurality of qualitative scores;
a weighting component that weights at least a subset of the plurality of qualitative scores to produce a plurality of weighted scores; and
a calculation component that generates a unified composite score based at least in part on the plurality of scaled scores and the plurality of weighted scores.

2. The system of claim 1, further comprising an importance component that receives a plurality of importance scores associated with the plurality of qualitative scores, wherein the importance scores are used at least in part by the weighting component to weight the plurality of quantitative scores.

3. The system of claim 2, wherein the weighting component weights at least the subset of the plurality of qualitative scores by summing the plurality importance scores to an importance sum and assigning an individual weight to an individual qualitative score among the plurality of qualitative scores based at least in part on an individual importance score among the plurality of importance scores as a proportion of the importance sum.

4. The system of claim 1, further comprising a task component that monitors the performance of a task to provide the plurality of quantitative scores.

5. The system of claim 1, further comprising an inquiry component that causes presentation of at least one inquiry to provide the plurality of qualitative scores.

6. The system of claim 1, wherein the calculation component generates the unified composite score based at least in part on the plurality of scaled scores, the plurality of weighted scores, and a non-weighted subset of scores from the plurality of qualitative scores.

7. The system of claim 1, wherein the scales are determined based at least in part on statistical analyses of the plurality of quantitative scores.

8. The system of claim 1, wherein the scaling component scales the plurality of quantitative scores to accord with a numerical system that expresses the plurality of qualitative scores.

9. A method for producing a composite score, comprising:
recording performance data related to a task;
scaling the performance data to scaled performance data;
recording satisfaction information related to the task;
weighting at least a portion of the satisfaction information to weighted satisfaction data; and
combining at least the scaled performance data, the weighted satisfaction data, and non-weighted portions of the satisfaction information to produce a unified composite score.

10. The method of claim 9, further comprising causing the performance of the task.

11. The method of claim 9, further comprising selecting a sample group of subjects to perform the task.

12. The method of claim 9, wherein the satisfaction information is described in at least one category.

13. The method of claim 12, further comprising collecting at least one importance rating respectively associated with the at least one category of satisfaction information.

14. The method of claim 13, wherein weighting at least the portion of the satisfaction information is based at least in part on the at least one importance rating.

15. The method of claim 9, further comprising calculating one or more scales based at least in part on the performance data for use in scaling the performance data.

16. The method of claim 9, wherein the scaling the performance data scales the performance data to conform to a numerical system used at least with the satisfaction information.

17. A method for combining objective and subjective scores, comprising:
recording a plurality of objective scores related to a tested feature's performance;
recording a plurality of experience scores related to the tested feature; and
combining the plurality of objective scores and the plurality of experience scores to produce a single combined score.

18. The method of claim 17, further comprising adjusting the plurality of performance scores to conform to a common index.

19. The method of claim 17, further comprising recording a plurality of importance scores that correspond to at least a subset of the plurality of experience scores.

20. The method of claim 19, further comprising adjusting at least the subset of the plurality of experience scores based at least in part on the plurality of importance scores.
